(19) United States
(12) Patent Application Publication
(10) Pub. No.: US 2007/0124148 A1
(43) Pub. Date: May 31, 2007

(54) SPEECH PROCESSING APPARATUS AND SPEECH PROCESSING METHOD

(75) Inventors: Yasuo Okutani, Kawasaki-shi (JP); Masayuki Yamada, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/560,660

(22) Filed: Nov. 16, 2006

(30) Foreign Application Priority Data
Nov. 28, 2005 (JP) 2005-342844

(51) Int. Cl. G10L 13/00

(52) U.S. Cl. 704/265

(57) ABSTRACT

A permission portion to permit application of fast-forward and an inhibition portion to inhibit application of fast-forward are discriminated in text. Upon speech synthesis of the text in a fast-forward setting, speech synthesis in the fast-forward setting is performed on the permission portion. Further, upon speech synthesis of the text in the fast-forward setting, regarding the inhibition portion, speech synthesis is performed in a manner different from that of the speech synthesis in the fast-forward setting, e.g., at a normal speaking rate.

### BACKGROUND OF THE INVENTION

1. Field of the Invention

The present invention relates to a speech processing apparatus with a fast-forward mode.

2. Description of the Related Art

Recently, speech output systems for vision-impaired people are proposed. In such a system, a speech output of the content of document data in a Web page or the like is produced by speech synthesis of the document data. Further, research and study on a speech fast-forward and fast-rewind function in speech synthesis are conducted for quick and efficient understanding of the outline of Web page document or the like by the vision-impaired people. The most popular speech fast-forward method is increasing the speaking rate of synthesized speech. Further, speech fast-forward by speech synthesis for quicker and more efficient understanding of document content is proposed in “The Journal of the Institute of Electronics, Information and Communication Engineers, TL2004-39 WIT2004-63 (2005-01)” (Document 1) and Japanese Patent Application Laid-Open No. Sho 63-231493 (Document 2). The Document 1 covers a study on speech fast-forward by two types of skipping methods, i.e., reading only links, and proceeding a cursor indicating a reading position in fixed units. Further, the Document 2 proposes a method of reading only headlines in a fast-forward mode.

However, according to the above fast-forward method of increasing the speaking rate and the fast-forward methods in the Documents 1 and 2, fast-forward and skipping are performed without considering significant portions as intended by the writer of the document. Accordingly, the users may have difficulty in catching the significant portions of the document, or such portions may be skipped.

### SUMMARY OF THE INVENTION

The present invention has been made in view of the above problems, and has its object to enable suppression of speech output fast-forward in significant portions as intended by a writer.

According to one aspect of the present invention, there is provided a speech processing apparatus comprising: a discrimination unit adapted to discriminate a permission portion to permit application of fast-forward and an inhibition portion to inhibit application of fast-forward, from text as a subject of speech synthesis; a first synthesis unit adapted to, upon speech synthesis of the text in a fast-forward setting, perform speech synthesis in the fast-forward setting, on the permission portion; and a second synthesis unit adapted to, upon speech synthesis of the text in the fast-forward setting, perform speech synthesis in a manner different from that of the fist synthesis unit, on the inhibition portion.

According to another aspect of the present invention, there is provided a speech processing method comprising: a discrimination step of discriminating a permission portion to permit application of fast-forward and an inhibition portion to inhibit application of fast-forward, from text as a subject of speech synthesis; a first synthesis step of, upon speech synthesis of the text in a fast-forward setting, performing speech synthesis in the fast-forward setting, on the permission portion; and a second synthesis step of, upon speech synthesis of the text in the fast-forward setting, performing speech synthesis in a manner different from that of the fist synthesis unit, on the inhibition portion.

Further features of the present invention will become apparent from the following description of exemplary embodiments with reference to the attached drawings.

### BRIEF DESCRIPTION OF THE DRAWINGS

FIG. 1 is a block diagram showing a hardware construction of a speech processing apparatus according to a first embodiment of the present invention;

FIG. 2 is a block diagram showing a module construction of the speech processing apparatus according to the first embodiment;

FIG. 3 is a flowchart showing speech synthesis processing according to the first embodiment;

FIG. 4 is an example of tagged text;

FIG. 5 is a flowchart showing speech synthesis processing according to a second embodiment of the present invention;

FIG. 6 illustrates an example of a tree structure obtained in structure analysis of the tagged text shown in FIG. 4 by a text structure analyzing unit 204;

FIG. 7 is a block diagram showing the module construction of the speech processing apparatus according to a third embodiment of the present invention;

FIG. 8 is a flowchart showing the speech synthesis processing according to the third embodiment;

FIG. 9 illustrates speech data in which fast-forward permission/inhibition information is added corresponding to previously-recorded speech waveform by a content publisher;

FIG. 10 is a block diagram showing the module construction of the speech processing apparatus according to a fifth embodiment of the present invention; and

FIG. 11 is a flowchart showing the flow of processing in the speech processing apparatus according to the fifth embodiment.

### DESCRIPTION OF THE EMBODIMENTS

Preferred embodiments of the present invention will now be described in detail in accordance with the accompanying drawings.

### First Embodiment

In a first embodiment of the present invention, a speech processing apparatus which inputs tagged text as typified by HTML text and converts a content extracted from the tagged text into a speech will be described. Note that “fast-forward” in the first embodiment means conduction of speech synthesis at a speaking rate faster than a normal speaking rate.

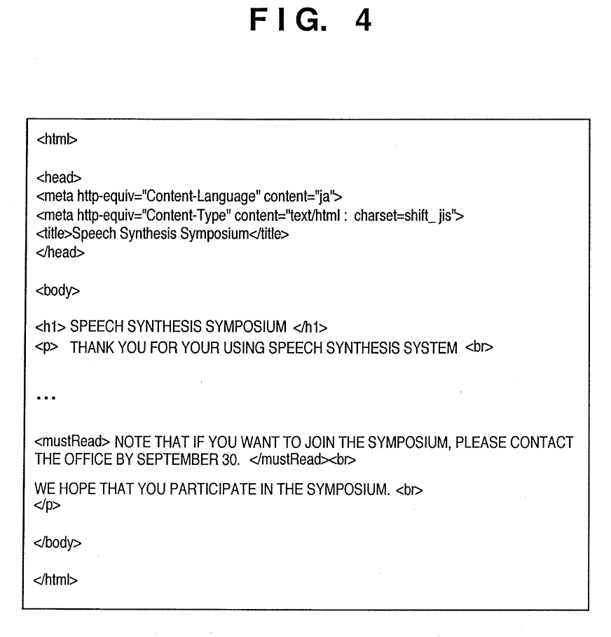

FIG. 4 is an example of tagged text as a subject to be read out by speech synthesis according to the first embodiment. A portion between a start tag <hl> and an end tag </hl> and a portion between a start tag <p> and an end tag </p> correspond to subjects to be read out by speech synthesis. Further, a document writer designates a portion to be directed to speech synthesis at a normal speaking rate even in a fast-forward mode (also referred to as a “fast-forward setting”) using a start tag <mustRead> and an end tag </mustRead>. In FIG. 4, a portion “Note that if you want to join the symposium, . . . by September 30.” is designated with the start tag <mustRead> and the end tag </mustRead>.

When the tagged text in FIG. 4 is inputted into the speech processing apparatus according to the present embodiment, speech synthesis processing is performed as follows.

When the output mode is the fast-forward mode, portions other than the portion which begins with the start tag <mustRead> and ends with the end tag </mustRead> are subjected to speech synthesis in the fast-forward setting. Further, the portion designated with the start tag <mustRead> and the end tag </mustRead> is subjected to speech synthesis at a normal speaking rate. On the other hand, when the output mode is not the fast-forward setting (fast-forward mode), all the portions are subjected to speech synthesis at the normal speaking rate regardless of designation with the start tag <mustRead> and the end tag </mustRead>.

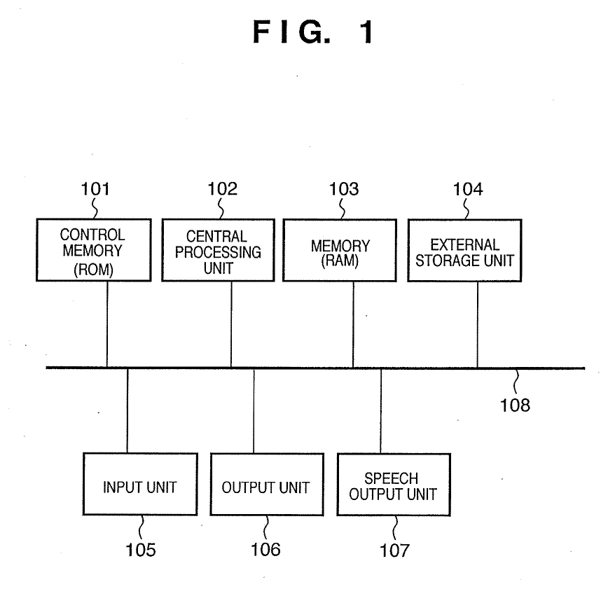

Next, the construction and operation of the speech processing apparatus according to the present embodiment having the above function will be described below with reference to FIGS. 1 to 3.

FIG. 1 is a block diagram showing a hardware construction of the speech processing apparatus according to the first embodiment.

In FIG. 1, a control memory 101 holds a speech processing procedure according to the present embodiment and necessary fixed data. A central processing unit (CPU) 102 performs numeric operation/control and the like. A memory 103 holds temporary data. An external storage unit 104 holds various data including document data to be processed and programs. The data and programs are loaded to the memory 103 in accordance with necessity. The input unit 105 is used by a user to input and instruct an operation with respect to the apparatus. An output unit 106 provides the user with various information under the control of the CPU 102. As the output unit 106, generally a display device such as a CRT or an LCD is employed. A speech output unit 107 outputs a synthesized speech generated by speech synthesis processing. The above respective units are connected to a bus 108, and data is transmitted among the units via the bus 108.

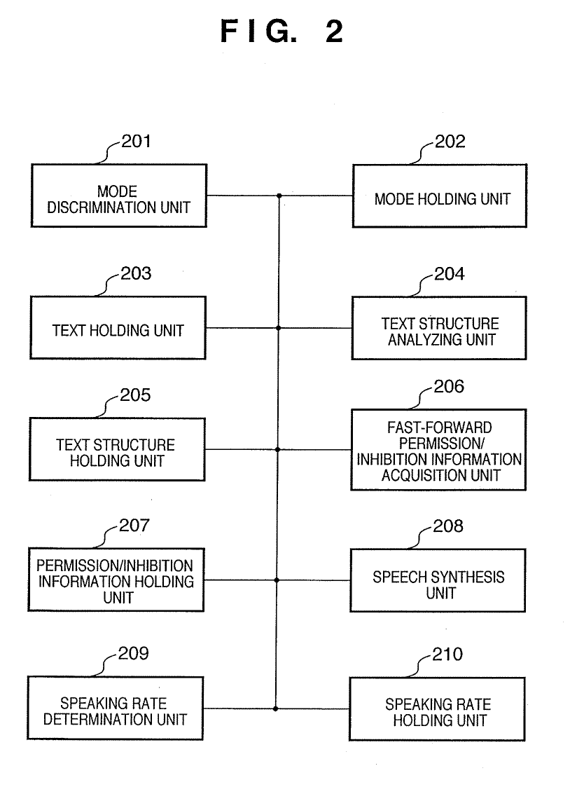

FIG. 2 is a block diagram showing a module construction of the speech processing apparatus according to the first embodiment. Note that the respective modules are realized by execution of a control program, loaded from the control memory 101 or the external storage unit 104 to the memory 103, by the CPU 102.

In FIG. 2, a mode discrimination unit 201 obtains an output mode and discriminates whether it is a fast-forward mode or not. The mode setting to the fast-forward mode or a normal mode is performed via the input unit 105. A mode holding unit 202 holds the result of discrimination by the mode discrimination unit 201. A text holding unit 203 holds tagged text as a subject of speech synthesis as shown in FIG. 4. A text structure analyzing unit 204 analyzes the tagged text held in the text holding unit 203, and obtains a content or control information. A text structure holding unit 205 holds the content or control information obtained by the text structure analyzing unit 204. A fast-forward permission/inhibition information acquisition unit 206 obtains fast-forward permission/inhibition information from the control information held in the text structure holding unit 205. A permission/inhibition information holding unit 207 holds the fast-forward permission/inhibition information obtained by the fast-forward permission/inhibition information acquisition unit 206. A speaking rate determination unit 209 determines a speaking rate of speech synthesis based on the mode information held in the mode holding unit 202 and the fast-forward permission/inhibition information held in the permission/inhibition information holding unit 207. A speaking rate holding unit 210 holds the speaking rate. A speech synthesis unit 208 performs speech synthesis in accordance with the speaking rate held in the speaking rate holding unit 210.

Note that the text structure analyzing unit 204 according to the present embodiment sequentially analyzes the tagged text. Further, the above holding units (202, 203, 205, 207 and 210) hold various data using the memory 103.

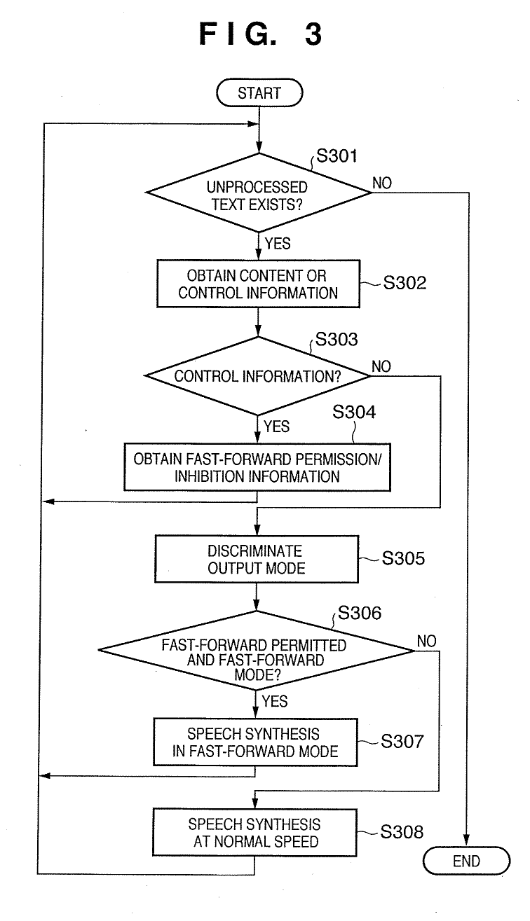

FIG. 3 is a flowchart showing processing in the speech processing apparatus according to the first embodiment. Hereinbelow, the speech processing according to the first embodiment will be described with reference to the flowchart of FIG. 3. Note that upon start of the processing shown in FIG. 3, the text holding unit 203 holds text document as shown in FIG. 4 including a character string to be read out (a character string which begins with a tag <p> and ends with a tag </p>).

At step S301, the text structure analyzing unit 204 discriminates whether or not an unprocessed portion exists in the tagged text held in the text holding unit 203. If it is discriminated that an unprocessed portion exists, the process proceeds to step S302, while if it is discriminated that there is no unprocessed portion, the process ends.

At step S302, the text structure analyzing unit 204 extracts a character string within a predetermined range from the head of the unprocessed portion in the tagged text held in the text holding unit 203. The extraction is performed in units of tag (“<” to “>”), or portion marked with tags indicating a content. The text structure analyzing unit 204 stores the character string extracted from the text holding unit 203 into the text structure holding unit 205. In the case of FIG. 4, “<h1>”→“Speech Synthesis Symposium”→“</h1>” is extracted.

Next, at step S303, it is determined whether or not the character string held in the text structure holding unit 205 is control information. If it is determined as a result of the determination that the character string is control information, the process proceeds to step S304. In this embodiment, when the character string is control information, the character string held in the text structure holding unit 205 is a character string describing a “tag”. That is, it is determined that the character strings <h1> and </h1> are control information. Further, other character string than the control information is a character string corresponding to the content described between the tags.

At step S304, the fast-forward permission/inhibition information acquisition unit 206 discriminates whether or not the control information represented with the character string held in the text structure holding unit 205 is to suppress fast-forward. In the present embodiment, as control information to suppress fast-forward, the tags <mustRead> and </mustRead> shown in FIG. 4 are used. These tags correspond to the start and the end of the fast-forward suppression range. At step S304, if it is determined that the control information held in the text structure holding unit 205 is a fast-forward suppression start tag (<mustRead> tag), the inhibition of fast-forward is held in the permission/inhibition information holding unit 207, and the process returns to step S301. On the other hand, if it is determined that the control information held in the text structure holding unit 205 is a fast-forward suppression end tag (</mustRead> tag), the permission of fast-forward is held in the permission/inhibition information holding unit 207, and the process returns to step S301. Further, if it is determined that the control information held in the text structure holding unit 205 is other than the fast-forward suppression control tags, the process returns to step S301.

In the present embodiment, if it is determined at step S303 that the character string held in the text structure holding unit 205 is not control information, the character string indicates a content. In this case, the process proceeds from step S303 to step S305. At step S305, the mode discrimination unit 201 obtains a current output mode, and stores whether the current output mode is the fast-forward mode or not into the mode holding unit 202. Next, at steps S306 to S308, the speaking rate determination unit 209 determines a speaking rate of speech synthesis based on the fast-forward permission/inhibition information held in the permission/inhibition information holding unit 207 and the mode information held in the mode holding unit 202, and stores the determined speaking rate into the speaking rate holding unit 210. That is, if the fast-forward permission/inhibition information indicates permission of fast-forward and the output mode is the fast-forward mode, the process proceeds from step S306 to step S307. At step S307, the speaking rate determination unit 209 stores a speaking rate corresponding to the fast-forward mode into the speaking rate holding unit 210. Then, the speech synthesis unit 208 performs speech synthesis on the character string held in the text structure holding unit 205 in accordance with the fast-forward speaking rate held in the speaking rate holding unit 210. As a result, the character string held in the text structure holding unit 205 is speech-synthesized in the fast-forward mode. In the present embodiment, the fast-forward speech synthesis is realized by voicing at a speaking rate faster than a normal speaking rate. Thereafter, the process returns to step S301.

On the other hand, if it is determined at step S306 that the fast-forward permission/inhibition information indicates inhibition of fast-forward or the output mode is not the fast-forward mode, the process proceeds to step S308. At step S308, the speaking rate determination unit 209 stores the normal speaking rate into the speaking rate holding unit 210. The speech synthesis unit 208 performs speech synthesis on the character string held in the text structure holding unit 205 in accordance with the normal speaking rate held in the speaking rate holding unit 210, and returns to step S301. As a result, the character string held in the text structure holding unit 205 is speech-synthesized at the normalspeaking rate.

The processing at steps S302 to S306 is determining as to whether or not the tagged content is to be permitted to be read out in fast-forward or inhibited be read out in fast-forward based on the contents of the tags. The above processing merely shows an example of the determination. Further, in the above example, the tagged text is used, however, any other type of text may be employed as long as there is indication of fast-forward permission/inhibition regarding a content.

As described above, according to the first embodiment, even when the output mode is the fast-forward mode, speech synthesis is performed at a normal speaking rate with respect to a character string within a range designated with predetermined control information (in the above example, the range between the tags <mustRead> and </mustRead>). Accordingly, the writer of a document as a subject of speech synthesis can easily designate a portion to be read out at a normal speaking rate even when the output mode is the fast-forward mode.

### Second Embodiment

In the first embodiment, the text structure analyzing unit 204 sequentially processes the text held in the text holding unit 203. However, the present invention is not limited to this processing. For example, the entire text may be analyzed at once. In the second embodiment, such processing will be described.

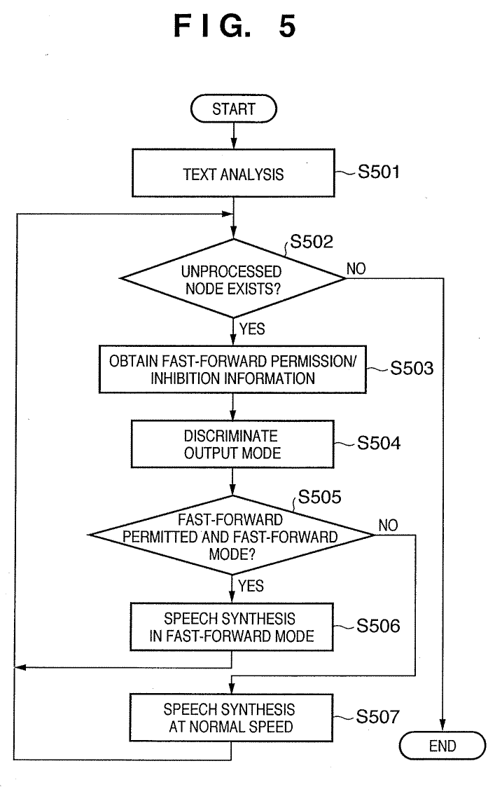

FIG. 5 is a flowchart showing the processing the speech processing apparatus according to the second embodiment. Note that as the module construction in the second embodiment is the same as that in the first embodiment, the explanation of the module construction will be omitted.

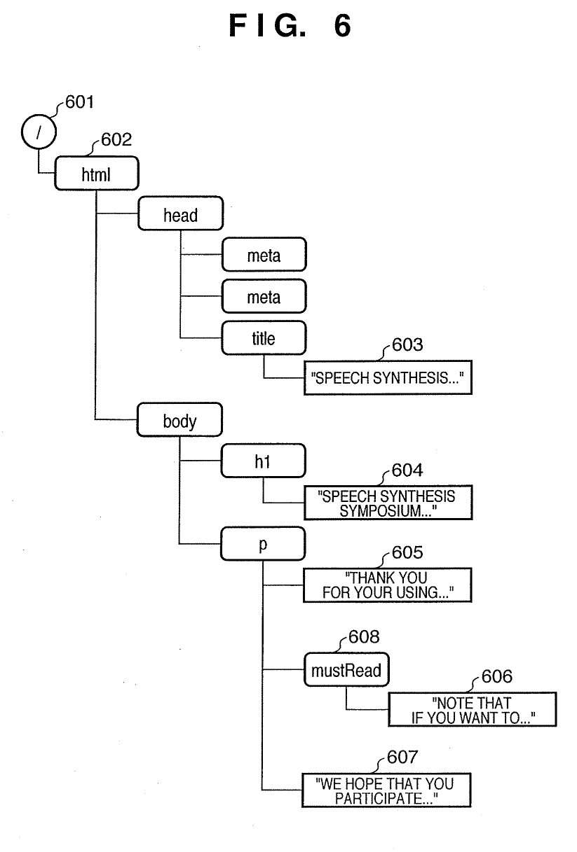

First, at step S501, the text structure analyzing unit 204 performs structure analysis on the tagged text held in the text holding unit 203. That is, the tree structure (to be described later in FIG. 6) of the tagged text and control information and contents of the respective nodes are discriminated, and the result of discrimination is held in the text structure holding unit 205. Next, at step S502, the tree structure is searched from the root and an unprocessed node regarding an initial content is selected. If an unprocessed node regarding the content exists, the process proceeds to step S503, while there is no unprocessed node, the process ends.

At step S503, the fast-forward permission/inhibition information acquisition unit 206 checks the nodes from the node selected at step S502 toward the root, to discriminate whether or not each node indicates a fast-forward suppression tag. If a fast-forward suppression tag exists between the selected node to the root, the fast-forward permission/inhibition information is set to “inhibition”, while if no fast-forward suppression tag exists, the fast-forward permission/inhibition information is set to “permission”, and the information is stored into the permission/inhibition information holding unit 207. Next, at step S504, the mode discrimination unit 201 discriminates whether or not the current output mode is the fast-forward mode, and stores the result of discrimination into the mode holding unit 202.

At step S505, the speaking rate determination unit 209 determines a speaking rate of speech synthesis based on the fast-forward permission/inhibition information held in the permission/inhibition information holding unit 207 and the mode information held in the mode holding unit 202, and branches the processing. That is, if the fast-forward permission/inhibition information indicates permission and the output mode is the fast-forward mode, the process proceeds to step S506. At step S506, the fast-forward speaking rate is stored as a speech synthesis speaking rate into the speaking rate holding unit 210. The speech synthesis unit 208 performs speech synthesis in the fast-forward mode. On the other hand, if the fast-forward permission/inhibition information indicates inhibition or the output mode is a normal mode, the process proceeds to step S507. At step S507, a normal speaking rate is stored as the speech synthesis speaking rate into the speaking rate holding unit 210, and the speech synthesis unit 208 performs speech synthesis at a normalspeaking rate. When the speech synthesis regarding the current node has been completed at step S506 or S507, the process returns to step S502.

FIG. 6 illustrates an example of a tree structure obtained in structure analysis of the tagged text in FIG. 4 by the text structure analyzing unit 204. In FIG. 6, numeral 601 denotes a root node of the tree. Nodes represented with rounded square blocks like nodes 602 and 608 indicate control information. Particularly, the node 608 is control information for fast-forward suppression. On the other hand, nodes 603 to 607 indicate contents.

For example, upon processing of the node 606 regarding the content, in the course of checking of nodes toward the root, the process passes through the node 608 as the fast-forward suppression control information (S503). Accordingly, when the node 606 is speech-synthesized, speech synthesis is performed at a normal speaking rate without fast-forward even if the output mode is the fast-forward mode (S504, S505 and S507). On the other hand, in the nodes 604, 605 and 607, in the course of checking of nodes toward the root, the process does not pass through a node indicating the fast-forward suppression control information. Accordingly, when the nodes 604, 605 and 607 are speech-synthesized, speech synthesis is performed in the fast-forward mode if the output mode is the fast-forward mode (S505 and S506). Note that as the node 603 is connected to a “title” tag in the head, this node is not subjected to speech synthesis. Further, as a node corresponding to a line break tag <br> in FIG. 4 does not relate to the subject matter of the present embodiment, it is omitted in FIG. 6.

As described above, according to the second embodiment, the permission or inhibition of the fast-forward mode upon speech synthesis is discriminated by referring to a tree structure.

### Third Embodiment

In the first and second embodiments, the “fast-forward mode” is realized by performing speech synthesis at a speaking rate faster than a normalspeaking rate. However, the fast-forward mode is not limited to this arrangement. For example, the “fast-forward mode” may be realized by skipping a content. In the third embodiment, the construction utilizing the “fast-forward mode” by skipping will be described. Note that in the third embodiment, the “fast-forward” is realized by reading out only “noun” words, based on the second embodiment.

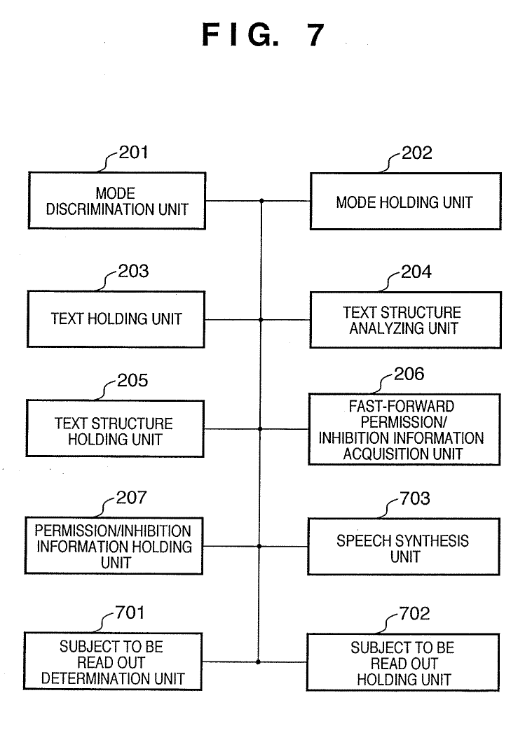

FIG. 7 is a block diagram showing the module construction of the speech processing apparatus according to the third embodiment. Note that the respective modules in FIG. 7 are realized by execution of a control program, loaded from the control memory 101 or the external storage unit 104 to the memory 103, by the CPU 102. In FIG. 7, the respective processing units 201 to 207 perform the same processings as those in the second embodiment. A subject to be read out determination unit 701 determines whether reading out is to be performed at a normal speaking rate or skipping is to be performed for the fast-forward mode based on the mode information held in the mode holding unit 202 and the fast-forward permission/inhibition information held in the permission/inhibition information holding unit 207. Then, if skipping is to be performed, the subject to be read out determination unit 701 determines word classes of the voice content by morphological analysis, and specifies “noun” words as subjects to be read out. A subject to be read out holding unit 702 holds only the words determined as nouns by the morphological analysis as subjects to be read out. A speech synthesis unit 703 performs speech synthesis on the nouns held in the subject to be read out holding unit 702 and outputs the result of synthesis. On the other hand, when skipping is not to be performed, the subject to be read out determination unit 701 stores the entire voice content as a subject to be read out into the subject to be read out holding unit 702. The speech synthesis unit 703 performs speech synthesis on the subject to be read out held in the subject to be read out holding unit 702 and outputs the result of synthesis.

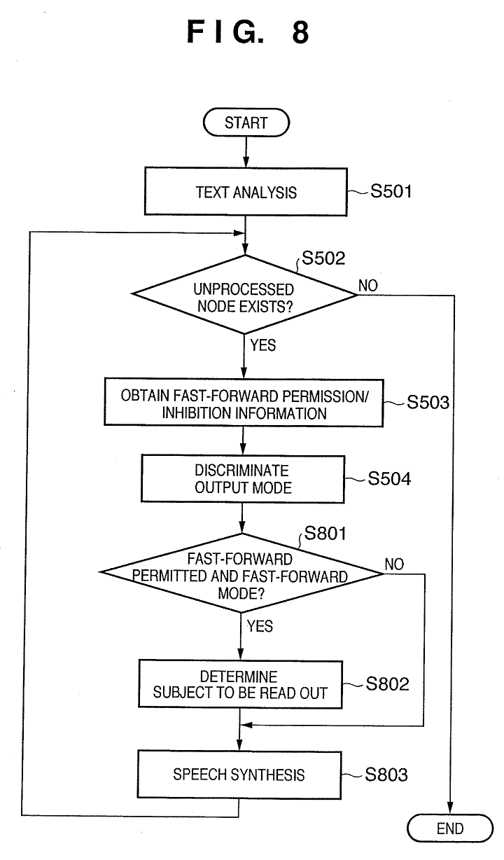

FIG. 8 is a flowchart showing the flow of processing in the speech processing apparatus according to the third embodiment. In FIG. 8, at respective steps S501 to S504, the same processings as those in the second embodiment (FIG. 5) are performed.

At step S801, the subject to be read out determination unit 701 determines whether or not voicing in the fast-forward mode is to be performed, i.e., whether or not skipping is to be performed, based on the fast-forward permission/inhibition information held in the permission/inhibition information holding unit 207 and the mode information held in the mode holding unit 202. If the fast-forward permission/inhibition information indicates permission and the output mode is the fast-forward mode, the process proceeds from step S801 to step S802 to perform speech synthesis in the “fast-forward mode”. At step S802, the subject to be read out determination unit 701 determines the word classes of the words in the current node by morphological analysis. Then the subject to be read out determination unit 701 stores “noun” words into the subject to be read out holding unit 702. Then the process proceeds to step S803, at which, the speech synthesis unit 703 performs speech synthesis on the words held in the subject to be read out holding unit 702, thereby a fast-forward mode speech synthesized output by skipping is obtained. Thereafter, when the speech synthesis regarding the current node has been completed, the process returns to step S502.

On the other hand, if the fast-forward permission/inhibition information indicates inhibition or the output mode is not the fast-forward mode, to perform speech synthesis at a normalspeaking rate, the entire voice content of the current node is stored into the subject to be read out holding unit 702, and the process proceeds from step S801 to step S803. At step S803, the speech synthesis unit 703 performs speech synthesis on the subject to be read out held in the subject to be read out holding unit 702. As a result, the entire content of the current node is speech-synthesized, and a normal speaking rate speech synthesized output can be obtained. When the speech synthesis regarding the current node has been completed, the process returns to step S502.

As described above, even when speech synthesis is performed by thinning a content in the fast-forward mode, as speech synthesis is performed at a normal speaking rate within a range where fast-forward suppression is designated, the user can infallibly catch the voice content designated by the writer.

### Fourth Embodiment

In the third embodiment, the “fast-forward” is realized by reading out only “noun” words, and when the fast-forward is inhibited, speech synthesis is performed without skipping. That is, as the speech synthesis in the “fast-forward mode”, the “fast-forward” is realized by changing the voice content (skipping) instead of changing the speaking rate. However, the changing of subject to be read out is not limited to the skipping. In the fourth embodiment, the “fast-forward” is realized by reading out a summarized content.

Note that the module construction and the flow of processing in the fourth embodiment are the same as those in the third embodiment, the fourth embodiment will be described with reference to FIGS. 7 and 8.

In FIG. 7, a subject to be read out determination unit 701 determines whether the content is to be read out in a normal manner or the content is to be summarized based on the mode information held in the mode holding unit 202 and the fast-forward permission/inhibition information held in the permission/inhibition information holding unit 207. If the content is to be summarized, the summarization is performed using an existing method based on semantic analysis, word significance or the like. Note that as the other modules perform the same processings as those in the third embodiment, the explanations of the other modules will be omitted.

In FIG. 8, at step S801, the subject to be read out determination unit 701 determines whether the voice content is to be read out in a normal manner or to be summarized and read out, based on the mode information held in the mode holding unit 202 and the fast-forward permission/inhibition information held in the permission/inhibition information holding unit 207. If the content is to be summarized, the process proceeds to step S802, otherwise, the content is stored into the subject to be read out holding unit 702, and the process proceeds to step S803.

At step S802, the subject to be read out determination unit 701 summarizes the content of the current node and stores it into the subject to be read out holding unit 702, then the process proceeds to step S803. Note that since the same processings as those in the second embodiment are performed at the other steps, the explanations of the other steps will be omitted.

As described above, even when speech synthesis is performed on a summarized content in the fast-forward mode, as speech synthesis is performed at a normal speaking rate within a range where fast-forward suppression is designated, the user can infallibly catch the content of a portion designated by the writer.

### Fifth Embodiment

In the first to fourth embodiments, upon reading out tagged text by speech synthesis, fast-forward is suppressed based on the fast-forward permission/inhibition information designated with tags, however, the fast-forward suppression is not limited to this arrangement. For example, upon play back of speech data with fast-forward permission/inhibition information, fast-forward may be suppressed based on the permission/inhibition information. Next, play back control of speech data with fast-forward permission/inhibition information will be described.

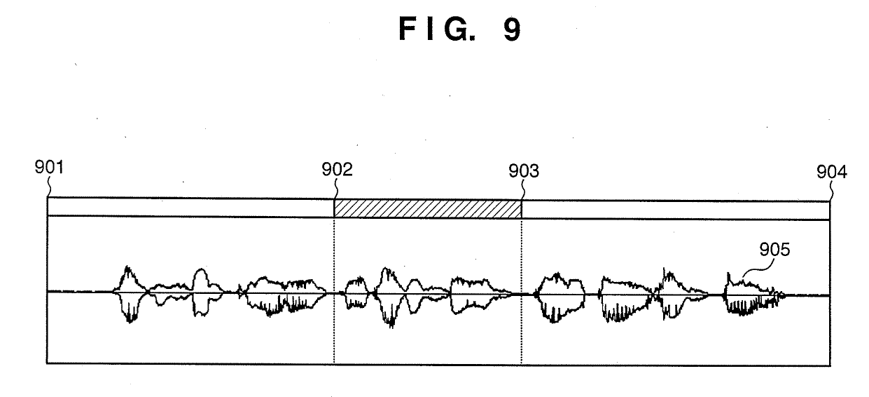

FIG. 9 illustrates fast-forward permission/inhibition information and speech data corresponding to the fast-forward permission/inhibition information. In FIG. 9, numerals 901 to 904 denote points (time points) corresponding to time information or waveform positions corresponding to the speech data. In this example, the fast-forward is permitted between the time points 901 and 902, the fast-forward is inhibited between the time points 902 and 903, and the fast-forward is permitted between the time points 903 and 904. Note that numeral 905 denotes a speech waveform indicating the speech data. In this manner, the content publisher associates the speech data with the fast-forward permission/inhibition information in advance. The association of the fast-forward permission/inhibition information is made by, e.g., selecting a section (speech section) of subject speech data and designating fast-forward permission/inhibition, or by setting a mode to designate a fast-forward portion and selecting a section of the subject speech data.

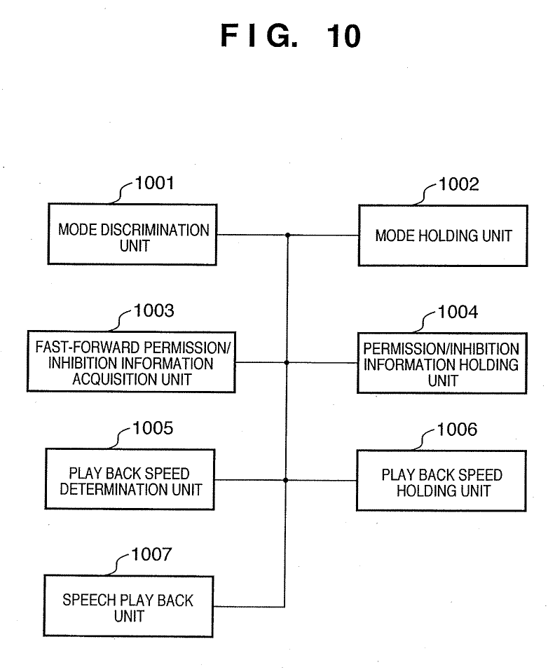

FIG. 10 is a block diagram showing the module construction of the speech processing apparatus according to a fifth embodiment. Note that the respective modules in FIG. 10 are realized by execution of a control program, loaded from the control memory 101 or the external storage unit 104 to the memory 103, by the CPU 102. A mode discrimination unit 1001 obtains an output mode and discriminates whether or not it is a fast-forward mode. Note that the output mode can be set to, e.g., the fast-forward mode and the normal mode, by the user's operation. A mode holding unit 1002 holds the result of discrimination by the mode discrimination unit 1001, i.e., output mode information indicating the output mode. A fast-forward permission/inhibition information acquisition unit 1003 obtains fast-forward permission/inhibition information attached to speech data. A permission/inhibition information holding unit 1004 holds the fast-forward permission/inhibition information obtained by the fast-forward permission/inhibition information acquisition unit 1003. A play back speed determination unit 1005 determines a play back speed based on the output mode information held in the mode holding unit 1002 and the fast-forward permission/inhibition information held in the permission/inhibition information holding unit 1004. A play back speed holding unit 1006 holds the play back speed determined by the play back speed determination unit 1005. A speech play back unit 1007 plays back the speech data in accordance with the play back speed held in the play back speed holding unit 1006. In the play back speed holding unit 1006, a play back speed for the fast-forward mode or a play back speed for the normal mode is held.

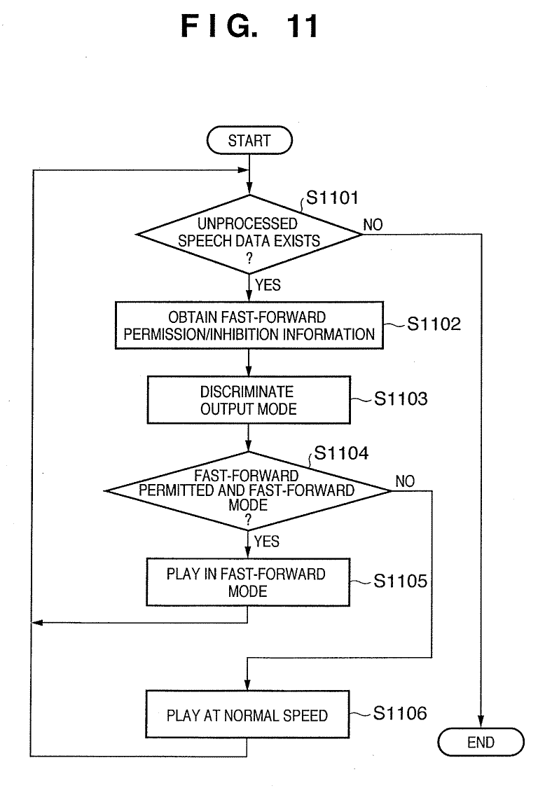

FIG. 11 is a flowchart showing the flow of processing in the speech processing apparatus according to the fifth embodiment. In the present embodiment, the play back of speech data is performed in predetermined frame units. Note that the play back unit is not limited to frame, but may be arbitrary unit such as sample.

First, at step S1101, if it is determined that unprocessed speech data exists, the process proceeds to step S1102, while if it is determined that there is no unprocessed speech data, the process ends. At step S1102, the fast-forward permission/inhibition information acquisition unit 1003 obtains fast-forward permission/inhibition information corresponding to the current frame, and stores the information into the permission/inhibition information holding unit 1004. In the present embodiment, the fast-forward is permitted with respect to the frames between the time points 901 and 902 and between the time points 903 and 904, while the fast-forward is inhibited with respect to the frames between the time points 902 and 903. Note that the acquisition of fast-forward permission/inhibition information is not limited to the above arrangement. For example, it may be arranged such that the fast-forward permission is set between the time points 901 and 902 and between the time points 903 and 904, while the fast-forward inhibition is set between the time points 902 and 903, and the fast-forward permission/inhibition information is obtained based on time point to which a subject frame belongs.

At step S1103, the mode discrimination unit 1001 discriminates whether or not the output mode is the fast-forward mode, and stores the result of discrimination into the mode holding unit 1002. Next, at steps S1104 to S1106, the play back speed determination unit 1005 determines a play back speed based on the fast-forward permission/inhibition information held in the permission/inhibition information holding unit 1004 and the mode information held in the mode holding unit 1002, and stores the play back speed into the play back speed holding unit 1006. That is, if the fast-forward permission/inhibition information indicates permission and the output mode is the fast-forward mode, the process proceeds to step S1005. At step S1005, the play back speed determination unit 1005 stores a play back speed corresponding to the fast-forward into the play back speed holding unit 1006. The speech play back unit 1007 plays back the current frame in accordance with the play back speed held in the play back speed holding unit 1006. Then the process returns to step S1101. On the other hand, if it is determined at step S1104 that the fast-forward permission/inhibition information indicates inhibition or the output mode is the normal mode, the process proceeds to step S1106. At step S1106, the play back speed determination unit 1005 stores a play back speed corresponding to a normal speaking rate into the play back speed holding unit 1006. The speech play back unit 1007 plays back the current frame in accordance with the play back speed held in the play back speed holding unit 1006. Then the process returns to step S1101.

As described above, according to the fifth embodiment, the fast-forward permission/inhibition information can be directly set in speech data.

### Other Embodiment

In the third embodiment, as an example of fast-forward, only “noun” words are read out and the other words are skipped, however, the fast-forward reading is not limited to this arrangement. For example, the fast-forward may be realized by selection based on word class, selection based on independent word/auxiliary word, or reading by arbitrary unit such as sentence, clause, phrase, word, fixed character length or fixed time length.

Further, in the fifth embodiment, a fast play back speed is used as an example of fast-forward, however, the fast-forward is not limited to this arrangement, but the fast-forward by skipping may be performed. As an example of skipping in the fifth embodiment, extraction and play back of speech data may be performed at predetermined time intervals. Otherwise, it may be arranged such that a voiceless portion in speech is detected, and a section from the voiceless portion to the next voiceless portion is determined as a read-out section. The play back is performed in every other read-out section. In this skipping, regarding speech data with fast-forward permission/inhibition information indicating inhibition, the play back is performed at a normal speed without skipping.

Further, in the third embodiment, the “fast-forward” is realized by skipping in speech synthesis, and regarding fast-forward inhibited speech, speech synthesis at a normal speaking rate is performed without skipping. However, the present invention is not limited to this arrangement. In a case where the efficiency of the fast-forward mode is important, it may be arranged such that speech synthesis of fast-forward inhibited content is performed at an increased speaking rate without skipping.

In addition to the above-described embodiments, the present invention can be implemented as a system, an apparatus, a method, a program or a storage medium. More particularly, the present invention can be applied to a system constituted by a plurality of devices or to an apparatus comprising a single device.

Furthermore, the invention includes a case where the functions of the foregoing embodiments are implemented by supplying a software program directly or indirectly to a system or apparatus, reading the supplied program code with a computer of the system or apparatus, and then executing the program code. In this case, the supplied program corresponds to the flowcharts shown in the figures in the embodiments.

Accordingly, since the program code installed in the computer to realize the functional processings of the present invention by the computer, also implements the present invention. In other words, the present invention also includes the computer program for the purpose of implementing the functional processings of the present invention.

In this case, as long as the system or apparatus has the functions of the program, the program may be executed in any form, such as an object code, a program executed by an interpreter, or script data supplied to an operating system.

Examples of storage media that can be used for supplying the program are a floppy (registered trademark) disk, a hard disk, an optical disk, a magneto-optical disk, a CD-ROM, a CD-R, a CD-RW, a magnetic tape, a non-volatile type memory card, a ROM, and a DVD (a DVD-ROM and a DVD-R).

As for the method of supplying the program, a client computer can be connected to a website on the Internet using a browser of the client computer, and the computer program of the present invention of the program can be downloaded to a recording medium such as a hard disk. In this case, the downloaded program may be an automatically-installable compressed file. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the case where the aforementioned functions according to the embodiments are implemented by executing the read program by a computer, an operating system or the like running on the computer may perform all or a part of the actual processing in accordance with designations of the program so that the functions of the foregoing embodiments can be implemented by this processing.

Furthermore, it may be arranged such that, after the program read from the storage medium is written to a function expansion board inserted into the computer or to a memory provided in a function expansion unit connected to the computer, a CPU or the like mounted on the function expansion board or function expansion unit performs all or a part of the actual processing in accordance with designation of the program, so that the functions of the foregoing embodiments can be implemented by this processing.

According to the present invention, in speech synthesis, fast-forward of speech output can be suppressed in a portion previously designated by a document writer. Accordingly, regarding the portion previously designated by the writer, as the fast-forward of speech output is suppressed, the invention reduces the probability that the user has difficulty in catching a significant portion, or the probability of skipping of such significant portion.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-342844, filed Nov. 28, 2005, which is hereby incorporated by reference herein in its entirety.

What is claimed is:

1. A speech processing apparatus comprising:
a discrimination unit adapted to discriminate a permission portion to permit application of fast-forward and an inhibition portion to inhibit application of fast-forward, from text as a subject of speech synthesis;
a first synthesis unit adapted to, upon speech synthesis of said text in a fast-forward setting, perform speech synthesis in the fast-forward setting, on said permission portion; and
a second synthesis unit adapted to, upon speech synthesis of said text in said fast-forward setting, perform speech synthesis in a manner different from that of said fist synthesis unit, on said inhibition portion.

2. The apparatus according to claim 1, wherein said text is tagged text where a content of said inhibition portion is placed between predetermined tags.

3. The apparatus according to claim 1, wherein said first synthesis unit performs speech synthesis at a speaking rate faster than that without said fast-forward setting.

4. The apparatus according to claim 1, wherein said first synthesis unit generates synthesized speech by thinning said text.

5. The apparatus according to claim 1, wherein said first synthesis unit generates synthesized speech by summarizing said votext.

6. The apparatus according to claim 1, wherein said second synthesis unit performs speech synthesis at a speaking rate which is used without said fast-forward setting.

7. The apparatus according to claim 2, wherein said discrimination unit analyzes said text, generates a tree having nodes in units of content or tag, and refers to said tree to discriminate whether a current content corresponds to said inhibition portion or said permission portion.

8. A speech processing method comprising:
a discrimination step of discriminating a permission portion to permit application of fast-forward and an inhibition portion to inhibit application of fast-forward, from text as a subject of speech synthesis;
a first synthesis step of, upon speech synthesis of said text in a fast-forward setting, performing speech synthesis in the fast-forward setting, on said permission portion; and
a second synthesis step of, upon speech synthesis of said text in said fast-forward setting, performing speech synthesis in a manner different from that of said fist synthesis unit, on said inhibition portion.

9. The method according to claim 8, wherein said text is tagged text where a of said inhibition portion is placed between predetermined tags.

10. The method according to claim 8, wherein at said first synthesis step, speech synthesis is performed at a speaking rate faster than that without said fast-forward setting.

11. The method according to claim 8, wherein at said first synthesis step, synthesized speech is generated by thinning said text.

12. The method according to claim 8, wherein at said first synthesis step, synthesized speech is generated by summarizing said text.

13. The method according to claim 8, wherein at said second synthesis step, speech synthesis is performed at a speaking rate which is used without said fast-forward setting.

14. The method according to claim 9, wherein at said discrimination step, said text is analyzed, a tree having nodes in units of content or tag is generated, and said tree is referred to for discrimination as to whether a current content corresponds to said inhibition portion or said permission portion.

15. A control program to cause a computer to perform the speech processing method in claim 8.
